(19) United States
(12) Patent Application Publication
(10) Pub. No.: US 2009/0241609 A1
(43) Pub. Date: Oct. 1, 2009

(54) SASH LOCKING SYSTEM

(76) Inventor: Giovanni Maria Laporta, Hertsfordshire (GB)

Correspondence Address: HAYES SOLOWAY P.C., 3450 E. SUNRISE DRIVE, SUITE 140, TUCSON, AZ, 85718, US

(21) Appl. No.: 11/721,797

(22) PCT Filed: Dec. 16, 2005
(86) PCT No.: PCT/GB05/04875

§ 371 Date: Jun. 14, 2007

(30) Foreign Application Priority Data
Dec. 18, 2004 (GB) 0427765.3
Apr. 8, 2005 (GB) 0507146.9

(51) Int. Cl. E05B 47/00; E05B 65/00; E05B 63/24

(52) U.S. Cl. 70/89

(57) ABSTRACT

The present invention provides a locking system for a sash window which comprises a first part that is installed in use within the sill of the sash window frame and which faces a second part that is mounted in use to the underside of the bottom rail of the lower sash wherein the first and second parts each have a respective complementary engaging parts whereof one of the complementary engaging parts of the first and the second parts is moveable relative to the other to lockingly engage with the other and which may be drawn away from locking engagement by use of a magnetic key.

### FIELD OF THE INVENTION

The present invention concerns a sash locking system for securing a sash window in a locked state.

### BACKGROUND TO THE INVENTION

Whereas over recent years there has been substantial advancement in the design of locking mechanisms for the more modern type of hinged windows there has been relatively little advancement in the design of locking mechanisms for the more conventional windows, sash windows, i.e. windows comprising sashes, or sliding frames, that run in substantially vertical grooves. Indeed, the most common system for locking a sash window closed involves use of a screw member passing from the top rail of the bottom sash into the bottom rail of the top sash to provide additional locking security over and above the normal swivel latch and keep between the two rails.

The conventional sash locking mechanisms are inconvenient and clumsy to operate. It is accordingly an objective of the present invention to provide a more user-friendly locking assembly for a sash window that may be readily used by the elderly or disabled or more generally by anyone with greater ease than conventional locking assemblies.

### SUMMARY OF THE INVENTION

According to a first aspect of the present invention there is provided a locking system for a sash window which comprises a first part that is installed in use to the sill of the sash window frame and which faces a second part that is mounted in use to the underside of the bottom rail of the lower sash wherein the first and second parts each have a respective complementary engagement means whereof one of the complementary engagement means of the first and second parts is moveable relative to the other to lockingly engage with the other and which, preferably, is biased towards locking engagement but may be drawn away from locking engagement by use of a magnetic key.

Preferably the magnetic key is a permanent magnet and which is handheld and whereby when the magnetic key is brought into proximity with an internal face of the sash window it will attract or repel a component of the first or second parts whereby they are disengaged from the locking state.

Preferably one of the first and second parts comprises a catch having the form of a protrusion having one of said complementary engagement means and the other of the first and second parts comprises a keep to receive the catch and having the other of the complementary engagement means therein. Suitably the said other complementary engagement means comprises a shoot bolt. Preferably the complementary engagement means on the catch comprises an aperture on the protrusion of the catch.

Suitably the shoot bolt is assembled on the keep substantially transverse to an axis of the keep along which the catch enters and withdraws from the keep. Suitably the shoot bolt is substantially perpendicular to said axis of the keep.

In one preferred embodiment of the invention the first part that is installed to the sill comprises the catch.

Preferably the shoot bolt is resiliently biased into locking engagement with the catch.

As a particularly preferred improvement, the locking system suitably further has a barrier component, e.g. a ferrous plate, that is installed in use to the sill or bottom rail of the lower sash to shield the moveable complementary engagement means against operation by a magnetic key advanced toward the moveable component from a wrong direction, i.e. direction other than that legitimately used by the operator and which for most purposes is the exterior face of the sash window. It will be appreciated that with certain configurations of the locking system such as where the moving shoot bolt is mounted to the lower sash rail, a very powerful magnet of reverse polarity approached towards the external face of the lower sash rail might be used to interfere with the shoot bolt. Accordingly, in a preferred embodiment the barrier plate to shield against “invalid” magnetic fields is mounted within the lower sash rail, shielding the shoot bolt from the external face of the lower sash rail.

A further preferred feature of the locking system is a releasable latching means for holding the moveable complementary engagement means/shoot bolt in a retracted state until the catch enters the keep but which is moved by the catch to free the moveable complementary engagement means to move. This latch means suitably comprises a resiliently deflectable component whose rest position blocks extending movement of the moveable complementary engagement means.

To facilitate installation of the locking system the system suitably further comprises a jig or template having a groove to seat over a ridge of the sill of the sash window and having a body with an aperture to define the area of the sill where the first part is to be inserted.

An alternative or additional feature to facilitate installation of the system comprises one or more demountable marker pins that demountably mount in use to one of the first and second parts projecting directly towards the other of the parts and whereby when the lower sash rail is advanced towards the sill the marker pins will mark the location where the other part is to be installed.

### BRIEF DESCRIPTION OF THE DRAWINGS

Two preferred embodiments of the present invention will now be more particularly described, by way of example, with reference to the accompanying drawings wherein:

FIG. 1 is a longitudinal sectional view through the lower end of a sash window, including through the sill and the bottom rail of the lower sash showing the locking system in place;

FIG. 2 is a view similar to FIG. 1 but showing the arrangement with the parts of the locking system also in section;

FIG. 3 is a view similar to FIG. 2 but showing the magnetic key positioned against the locking system to draw the shoot bolt of the sill mounted first locking part from locking engagement with the catch of the second part of the locking system on the underside of the bottom sash rail, and with the bottom sash thereby released and shown partly raised away from the sill in consequence;

FIG. 4 is a perspective view of the first and second parts of the locking system demounted from the sash window and alongside the magnetic key;

FIG. 5 is a perspective view from above of a jig/template device for assisting the installer in fitting the sill mounted first part of the system to the sill.

FIG. 6 is a longitudinal sectional view similar to that of FIG. 1 but through a second preferred embodiment of the invention wherein the catch is on the first part of the locking system fitted to the sill;

FIG. 7 is a perspective view corresponding to FIG. 6;

FIG. 8 is an exploded assembly view through the locking system of the second preferred embodiment as the catch begins to enter the keep;

FIG. 9 is a view similar to FIG. 8 but with the shoot bolt and catch inter- engaged;

FIG. 10 is a perspective view similar to FIG. 7 but with a pair of marker pins mounted to the sash mounted part of the locking system to easily mark the correctly aligned location for the sill mounted part during installation; and

FIG. 11 is a transverse sectional view similar to FIG. 6 but showing the marker pins.

### DESCRIPTION OF THE PREFERRED EMBODIMENTS

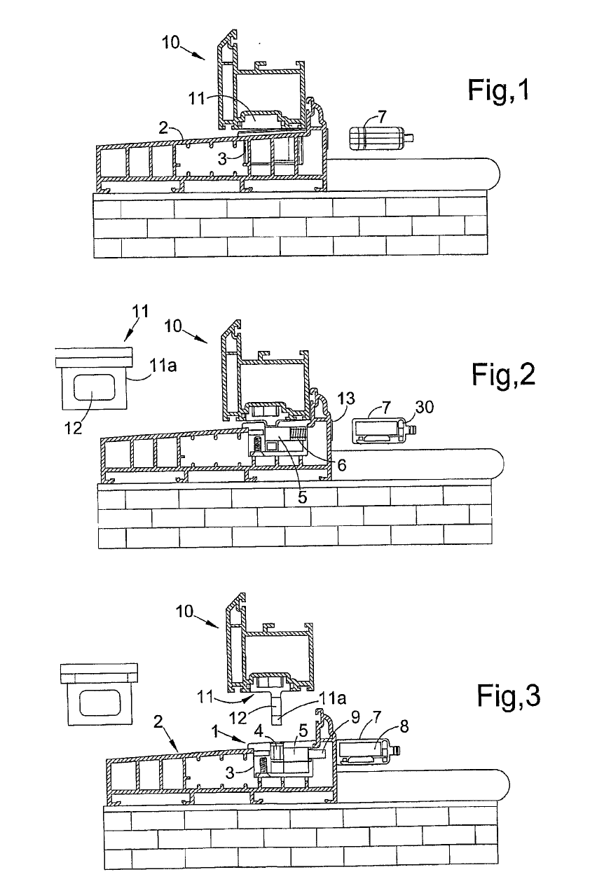

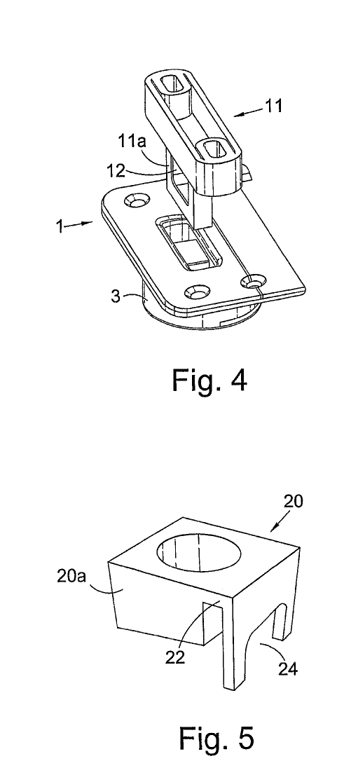

As can be seen in FIG. 1, the locking system of the present invention has a first part 1 that is mounted in use within the sill 2 of the sash window and which is illustrated as having a substantially circular cylindrical body portion 3.

The cylindrical body/casing 3 of the sill mounted part 1 has a void 4 at its centre defining a first keep and further houses a shoot bolt 5 adjacent and transverse to the axis of the keep 4 and mounted within the cylindrical body/casing 3 to be moveable between an extended position where it extends into the bore of the keep 4 and a retracted position where it does not.

The shoot bolt 5 is resiliently biased to an extended state by a resilient biasing means/compression spring 6 within the casing 3 but the force of that resilient biasing means 6 is selected to be of a level where it may be overcome by use of a magnetic key 7 housing a permanent magnet 8 when the magnetic key 7 is brought into proximity with the sill 2 and the shoot bolt 5 there within.

The shoot bolt 5 itself may be magnetic/ferrous/magnetisable or it may, as illustrated, have a magnetic or magnetisable actuator component 9 linked to it and which is adapted to be attracted by placement of the key 7 there adjacent (see FIG. 3). Of course, the invention further encompasses a reverse configuration in which the magnetic key 7 repels the magnetic/magnetisable component 9 of the sill- mounted part 1 of the locking system by provision of a linkage or other mechanism that will cause the shoot bolt 5 to retract from its extended position in the keep 4.

On the underside of the bottom rail 10 of the lower sash is mounted the second part 11 of the locking system and which comprises a catch in the form of an apertured protrusion 11 a that projects downwardly from the underside of the bottom rail 10 and is adapted to pass into the keep 4 of the sill mounted part 1. The aperture 12 in the catch protrusion 11a receives and co-operatively engages with the shoot bolt 5 whereby when the protrusion 11a is brought down to be housed in the keep 4 on closing of the window (with the shoot bolt 5 initially retracted by holding the magnetic key 7 in proximity) the protrusion 11a may be locked in the keep 4 simply by removing the magnetic key to allow the shoot bolt to be driven forward by its resilient biasing means/compression spring 6 into the aperture 12 of the catch protrusion 11a.

To unlock the sash window all the user need do is bring the magnetic key 7 back into proximity with the magnetic/magnetisable component 9 of the sill mounted part 1 to thereby cause the shoot bolt 5 to be retracted from engagement with the aperture 12 of the protrusion 11a and allowing the lower sash to be raised.

The magnetic key 7 suitably is provided with a visual indicator of when it is operative, having an LED 30 or similar that is energised to light up when the magnet 8 within the magnetic key 7 is brought into proximity with the magnetic/magnetisable component 9 of the sill mounted part 1. This may occur through, for example, the magnet 8 shifting within the magnetic key 7 and thereby to make an electrical circuit to energise the LED.

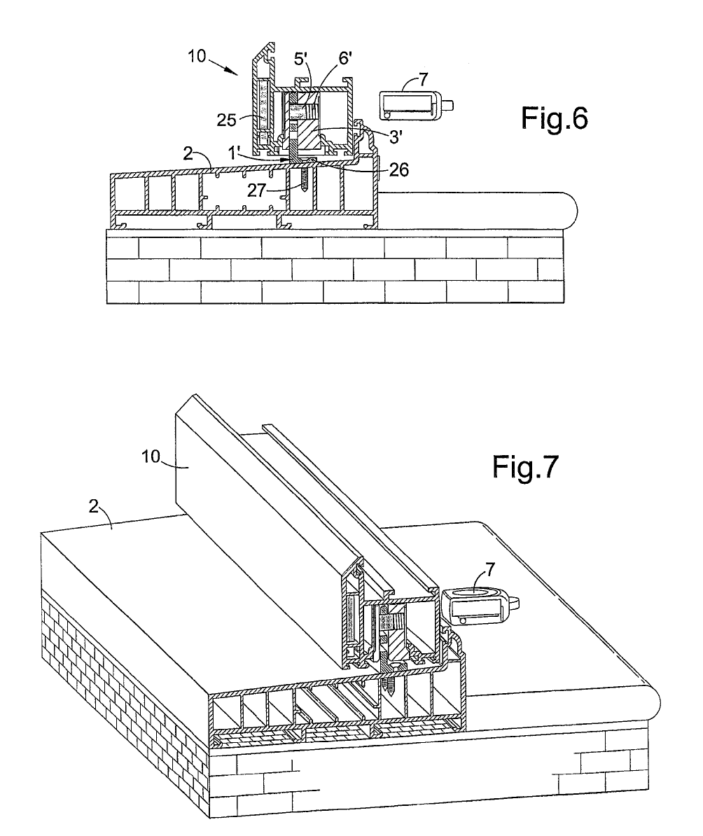

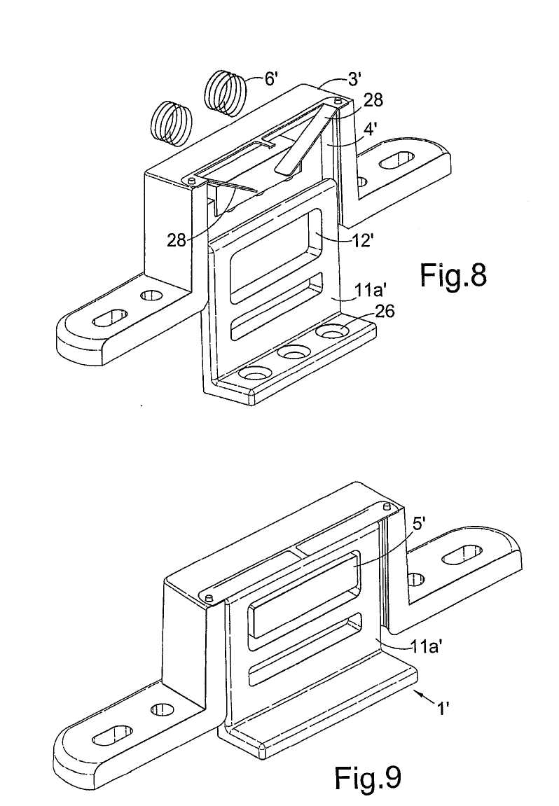

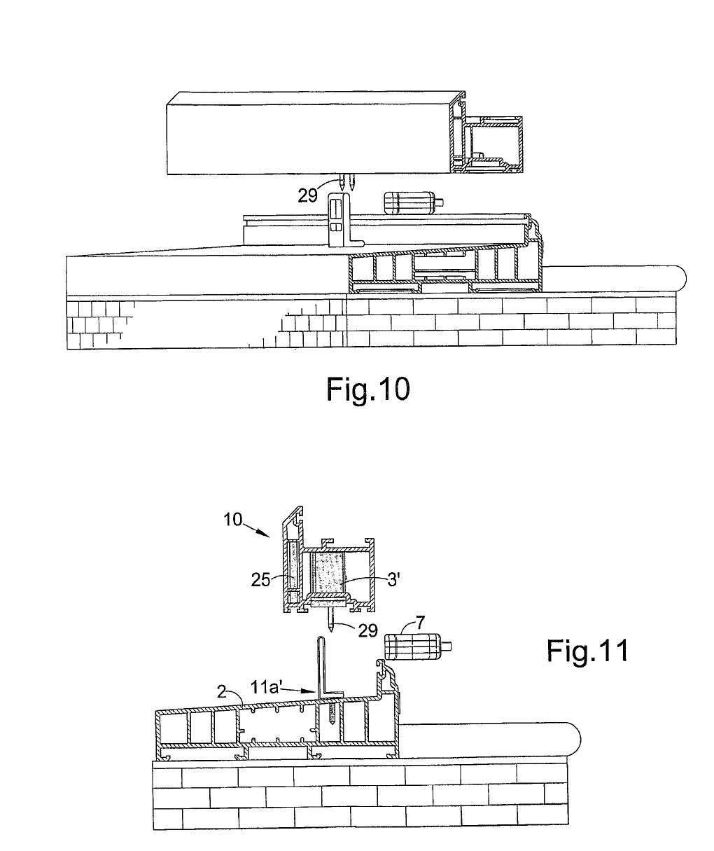

Though in the first illustrated embodiment the catch comprising protrusion 11a is shown as mounted to the bottom rail of the sash the respective positions of the protrusion 11a and the keep 4 for the protrusion 11a may be reversed, whereby the keep 4 is provided in the part that is mounted to the sash and the catch protrusion 11a is provided in the part that is mounted to the sill, for which see the second embodiment described below with respect to FIG. 6 to 11.

To guide the user where to place the magnetic key 7 to actuate the retraction of the shoot bolt 5, there is suitably provided a guide marker/plate 13 that is mounted on the internal face of the sill 2 directly overlying the actuator extension of the shoot bolt 5.

In order to facilitate the installation of the sill mounted part 1 of the system, a jig or template device 20 is suitably provided having a form such as illustrated in FIG. 5. This device 20 is suitably a metal block or moulding that has a main body portion 20a having a bore extending downwardly there through to guide a router or drill for carving out from the sill 2 the necessary void into which the cylindrical casing/body 3 of the sill mounted part 1 will sit. The jig/template device 20 has a bridging extension 22 that hooks over a lip 23 (see FIG. 3) of the sill 2 to hold the device 20 in place and which has a recess 24 to indicate where the marker/plate 13. be positioned on the inner face of the sill 2. When installed in the void the sill mounting part 1 is bolted or screwed in place.

Turning now to the second preferred embodiment of the present invention as illustrated in FIGS. 6 to 11, here the locations of the catch 11a′ and keep 3′ of the locking. system are switched over. The keep 3′ is here mounted to the bottom sash member 10 whereas the catch 11a′ is mounted to the sill 2. In this second embodiment, the shoot bolt 5′ is again resiliently biased to an extended state by resilient biasing means/compression spring 6′ within the casing 3′ and where the force of the resilient biasing means 6′ is selected to be of a level where it may be overcome by use of magnetic key 7. As in the first embodiment, the second embodiment suitably uses the key 7 to magnetically attract shoot bolt 5′ pulling it back against the spring 6′ and back away from co-operative engagement with the aperture 12′ of the catch protrusion 11a′.

Since here the shoot bolt is mounted to the lower sash rail 10, a very powerful magnet of reverse polarity placed against the external face of the lower sash rail might conceivably be used to interfere with the shoot bolt 5′. Accordingly a ferrous barrier plate 25 to shield against magnetic fields from the front/external face of the lower sash rail is mounted within the lower sash rail 10 at the front.

Furthermore, for the user's convenience in order to avoid the need to use the key 7 to retract the shoot bolt 5′ when closing the sash the member 10 on to the sill 2, a latching element 28 is provided that will hold the shoot bolt 5′ in retracted state until the leading end of the catch protrusion 11a′ is inserted into chamber 4′ of the keep 3′. Here the latching means 28 is shown as a pair of leaf springs 28 on the keep 3′ that are generally angled downwardly into the chamber 4′ of the keep but which may be deflected upwardly as the leading edge of the protruding part 7a40 enters chamber 4′ and thereby pushed up away from locking the shoot bolt 5′ so that it may be shot forward by the spring 6′ and into engagement with the aperture 12′ of the protrusion 11a′. Though not illustrated above with respect of the first embodiment of the invention, such an automatic latching arrangement may be employed in directly analogous fashion on that first embodiment.

To facilitate installation of the locking system of the second preferred embodiment, a pair of marker pins/spike-ended rods 29 are suitably demountably mounted to the sash mounted keep 3′, whereby when the sash 10 is lowered the marker pins 29 will puncture the upper surface of the sill 2 at precisely the locations where screws 27 may be tapped into the sill 2 to secure the sill mounting part 1′ with the protrusion 11′ in accurate alignment with the keep 4′ of the sash mounted part 3′.

The marker pins 29 may be fitted in recesses in the keep casing 3′ and as the sash is lowered the pins 29 will define where the countersunk sockets 26 of the sill- mounted part 1′ should be located to subsequently receive screws 27 to secure the sill mounted part 1′ in place. The marker pins 29 may then be demounted when they are no longer required, e.g. by pulling out with pliers. By this arrangement the user may very easily align the respective first and second parts of the locking system for efficient and effective operation. The configuration of the system as illustrated is extremely versatile and allows for substantial variation in the shapes and respective positions of the sash and sill, including e.g. for different angles of sill, and is simple to install and to operate.

1. A locking system for a sash window which comprises a first part that is installed in use to the sill of the sash window frame and which faces a second part that is mounted in use to the underside of the bottom rail of the lower sash wherein the first and second parts each have a respective complementary engaging parts whereof one of the complementary engaging parts of the first and second parts is moveable relative to the other to lockingly engage with the other and which may be drawn away from locking engagement by use of a magnetic key.

2. A locking system for a sash window as claimed in claim 1, wherein the movable complementary engaging part is biased towards locking engagement with the complementary engaging part.

3. A locking system for a sash window as claimed in claim 1, wherein the magnetic key is a permanent magnet and which is handheld and whereby when the magnetic key is brought into proximity with an internal face of the sash window it will attract or repel the movable complementary engaging parts whereby the first and second parts are disengaged from the locking state.

4. A locking system for a sash window as claimed in claim 1, wherein one of the first and second parts comprises a catch having the form of a protrusion incorporating one of said complementary engaging parts and the other of the first and second parts comprises a keep to receive the catch and having the other of the complementary engaging parts therein.

5. A locking system for a sash window as claimed in claim 4, wherein the movable complementary engaging parts comprise a shoot bolt.

6. A locking system for a sash window as claimed in claim 4, wherein the complementary engaging parts on the catch comprise an aperture on the protrusion of the catch.

7. A locking system for a sash window as claimed in claim 4, wherein the shoot bolt is assembled on the keep substantially transverse to an axis of the keep along which the catch enters and withdraws from the keep.

8. A locking system for a sash window as claimed in claim 4, wherein the first part that is installed to the sill comprises the catch.

9. A locking system for a sash window as claimed in claim 1, which further comprises a barrier component that is installed in use to the sill or bottom rail of the lower sash to shield the moveable complementary engaging parts from operation by a magnetic key advanced toward the moveable component from a direction other than that legitimately used by the operator

10. A locking system for a sash window as claimed in claim 9, wherein a barrier plate to shield against magnetic fields is mounted within the lower sash rail shielding the shoot bolt from the external face of the lower sash rail.

11. A locking system for a sash window as claimed in claim 1, which further comprises a releasable latch for holding the moveable complementary engaging parts in a retracted state until the catch enters the keep but which is moved by the catch to free the moveable complementary engaging parts to move.

12. A locking system for a sash window as claimed in claim 1, wherein the system further comprises a jig component having a groove to slot over a ridge of the sill of the sash window and having a body with an aperture to define the area of the sill where the first part is to be inserted.

13. A locking system for a sash window as claimed in claim 1, wherein the system further comprises one or more demountable marker pins that demountably mount in use to one of the first and second parts projecting directly towards the other of the parts and whereby when the lower sash rail is advanced towards the sill the marker pins will mark where the other part is to be installed.
